(19) United States
(12) Patent Application Publication
(10) Pub. No.: US 2025/0334157 A1
(43) Pub. Date: Oct. 30, 2025

(54) PISTON FOR AN ACTUATOR MECHANISM, COMPRISING A NUT AND A BUSHING

(71) Applicant: NTN EUROPE, Annecy (FR)

(72) Inventor: Julien BERTHIER, Saint-Jorioz (FR)

(73) Assignee: NTN EUROPE, Annecy (FR)

(21) Appl. No.: 19/174,983

(22) Filed: Apr. 10, 2025

(30) Foreign Application Priority Data
Apr. 25, 2024 (FR) FR2404264

(51) Int. Cl. F16D 65/14; F16D 125/40; F16H 25/22; F16H 25/24

(52) U.S. Cl. CPC F16D 65/14; F16H 25/2204; F16H 25/24; F16D 2125/40

(57) ABSTRACT

A piston of an actuator mechanism, the piston including a worm gear mechanism nut, the nut including an outer peripheral wall and a nut thread for cooperating, directly or via balls, with a worm gear mechanism screw; a bushing integral with the nut and at least partially covering the outer peripheral wall of the nut, the bushing comprising a cylindrical guide zone intended to come into close sliding contact with an inner guide wall of a guide cylinder of the actuator mechanism. The nut comprises at least one annular shrink-fit bearing surface, the bushing includes at least one shrink-fit zone shrink-fitted onto the annular shrink-fit bearing surface. The guide zone has a larger outer diameter than the shrink-fit zone and overlaps a covered portion of the outer peripheral wall of the nut without contact or shrink-fitting.

### CROSS-REFERENCE TO RELATED APPLICATIONS

This application claims the benefit of priority under 35 U.S.C. 119 from French Patent Application No. FR2404264, filed Apr. 25, 2024; the disclosure of which is incorporated herein by reference in its entirety.

### FIELD

The invention relates to the field of actuators, particularly for the transport industry, especially automotive or aerospace, especially pistons in mechanisms driven by a worm screw, in particular a ball screw, and more particularly, although not exclusively, brake pad pistons in braking mechanisms driven by a worm screw, in particular a ball screw.

### BACKGROUND

French patent application FR 2402914, unpublished at the date of filing of the present application, discloses a brake actuator mechanism comprising a screw, a nut shrink-fitted in a bushing, and balls positioned between a helical thread of the screw and a helical thread of the nut, the nut and bushing forming a piston sliding within a guide cylinder. The piston formed by the nut and bushing requires particularly careful dimensional control at the manufacturing stage, to ensure effective shrink-fitting without deforming any of the piston components when the bushing is assembled on the nut. This is because the application requires very narrow dimensional tolerances for the piston, in order to achieve virtually clearance-free, friction-free sliding of the piston in the cylinder.

### SUMMARY

The purpose of the invention is to overcome the disadvantages of the prior art and to propose a simple solution constructing a piston that meets narrow dimensional tolerances.

According to a first aspect of the invention, a piston of an actuator mechanism is proposed, the piston comprising a nut of a worm gear mechanism, defining a reference axis, an outer peripheral wall and a nut thread intended to cooperate, directly or via balls, with a worm gear mechanism screw; a bushing integral with the nut and at least partially covering the outer peripheral wall of the nut, the bushing comprising a cylindrical guide zone intended to come into close sliding contact with an inner guide wall of a guide cylinder of the actuator mechanism; remarkable in that the nut comprises at least one annular shrink-fit bearing surface, the bushing comprises at least one shrink-fit zone shrink-fitted onto the annular shrink-fit bearing surface, the guide zone having an outer diameter greater than that of the shrink-fit zone and overlapping, without contact or shrink-fitting, a covered portion of the outer peripheral wall of the nut.

The bushing comprises a zone shrink-fitted onto the nut, ensuring cohesion of the assembly formed with the piston. This zone can deform freely during shrink-fitting, without exceeding the outer template defined by the outer diameter of the guide zone. The guide zone of the bushing, meanwhile, is not deformed during assembly on the nut, thus guaranteeing its sizing. The result is a piston that does not require grinding of the guide zone of the bushing after assembling the bushing onto the nut, thereby reducing the costs associated with this grinding process. The fact that no grinding is required after assembly also means that the guide zone of the bushing can be thermochemically surface-treated before assembly on the nut, to give it specific mechanical characteristics that would be lost if the guide zone had to be ground. In the case of a bushing made from a different material than the nut, the effects of differential thermal expansion between the bushing and nut due to temperature fluctuations are confined to the bushing's shrink-fit zone and have no appreciable effect on the guide zone.

According to one embodiment, the guide zone and the covered portion of the outer peripheral wall of the nut are separated by an intermediate annular space generated by:
an annular recess in the covered portion of the outer peripheral wall of the nut relative to the annular shrink-fit bearing surface; and/or
an inner diameter of the guide zone greater than an inner diameter of the shrink-fit zone.

According to one embodiment, the intermediate annular space has a length L1 measured parallel to the reference axis, and a depth P, measured radially between the outer peripheral wall of the nut and a cylindrical inner face of the bushing guide zone, and the nut has a nut length L2 measured in an axis parallel to the reference axis between two ends of the nut, such that

$$L 1 > 20 P ; and / or$$

$$L 2 / 2 < L 1 < L 2.$$

The intermediate annular space therefore does not have a large radial dimension, as the space between the bushing and the nut is not necessarily large but has a significant annular volume owing to its axial dimension. This makes it possible to create a substantial and uniform intermediate annular space on part of the nut or bushing, along which no shrink-fitting forces are transmitted, in order to meet the need to maintain the external radial dimensions of the bushing.

In one embodiment, the nut comprises a second annular shrink-fit bearing surface, and the bushing comprises a second shrink-fit zone in contact with the second annular shrink-fit bearing surface of the nut. Preferably, the two annular shrink-fit zones are axially spaced apart, for example at two opposite axial ends of the guide zone. In this way, the bushing is shrink-fitted onto both ends of the nut, giving it a stable, reliable connection, while having an intermediate zone not shrink-fitted onto the nut, enabling it to maintain its desired radial dimensions. Preferably, no more than two shrink-fit zones are provided.

According to one embodiment, the bushing has a shrink-fit end-of-stroke shoulder turned in an axial assembly direction, resting against an annular end face of the nut, which enables the nut to abut against the bushing, ensuring correct axial positioning of the bushing on the nut and correspondence of the shrink-fit zones on the annular shrink-fit bearing surfaces.

According to one embodiment, the nut comprises a crimping mortise and the bushing has a flap of crimping material penetrating into the crimping mortise and bearing against a crimping shoulder of the crimping mortise, thereby locking the connection between the bushing and the nut, and thus reducing the risk of micromovements of the bushing against the surface of the nut, such movements being capable of causing wear to the shrink-fitted zones by frictional corrosion.

Preferably the nut comprises a locking mortise and the bushing has a locking slot open to the locking mortise, the piston further comprising a slipper inserted in the locking mortise and projecting radially from the guide zone. This mortise is designed to be inserted into a guide groove in the piston-accommodating cylinder, to prevent the piston from rotating in the cylinder about the reference axis, while allowing translational movements. In addition, the slipper is an additional means of connection between the bushing and the nut, reducing the risks associated with any movement of the bushing on the nut.

According to one embodiment, the bushing comprises a nitrogen-rich abrasion- and corrosion-resistant surface layer, and the nut comprises a carbon-rich hardened surface zone at least locally at the nut thread. As a result, the bushing is more resistant to the fretting generated by friction against the guide cylinder when the piston is operating in the guide cylinder, making the bushing, and therefore the piston, stronger and more durable.

According to one embodiment, the piston has a piston crown formed by the bushing or nut. The piston crown is designed to rest on a brake shoe to actuate the brake. Advantageously, it can be covered externally with a surface coating, such as a layer of zinc flake.

According to another aspect of the invention, a brake actuator mechanism, comprising:
a guide cylinder;
a ball screw mechanism, comprising a screw and a nut defining a reference axis of the brake actuator mechanism, and balls, the screw having at least one screw thread forming a raceway for the balls, the nut having a nut thread forming an outer helical raceway for the balls and an outer peripheral wall; and
a bushing integral with the nut and at least partially covering the outer peripheral wall of the nut, the bushing coming into close sliding contact with an inner guide wall of the guide cylinder, the bushing and nut constituting a piston as previously described.

The piston preferably has a crown, as previously mentioned, materialized by the bushing or nut, and intended to come to bear on a brake shoe or, more generally, a brake member in order to actuate it.

### BRIEF DESCRIPTION OF THE FIGURES

Other features and advantages of the invention will become apparent on reading the following description, with reference to the appended figures, which show:

FIG. 1 shows an axial cross-sectional view of a brake actuator mechanism comprising a ball screw mechanism having a screw, a nut and a bushing according to a first embodiment, wherein the nut has an annular recess.

FIG. 2 shows an axial cross-sectional view of the ball screw mechanism according to the embodiment of FIG. 1.

FIG. 3 shows a detailed cross-sectional view of a first shrink-fit zone of the nut according to the embodiment of FIG. 1.

FIG. 4 shows a detailed cross-sectional view of a second shrink-fit zone of the nut according to the embodiment of FIG. 1.

FIG. 5 shows a detailed cross-sectional view of a part of the nut comprising a mortise according to the embodiment of FIG. 1.

FIG. 6 shows a detailed cross-sectional view of a first shrink-fit zone of the nut according to a second embodiment wherein the bushing has a secondary annular recess.

FIG. 7 shows a detailed cross-sectional view of a second shrink-fit zone of the nut according to the embodiment of FIG. 6.

FIG. 8 shows an axial cross-sectional view of the ball screw mechanism according to a third embodiment wherein the bushing has a bottom.

For greater clarity, identical or similar elements are identified by identical reference signs in all of the Figures.

### DETAILED DESCRIPTION

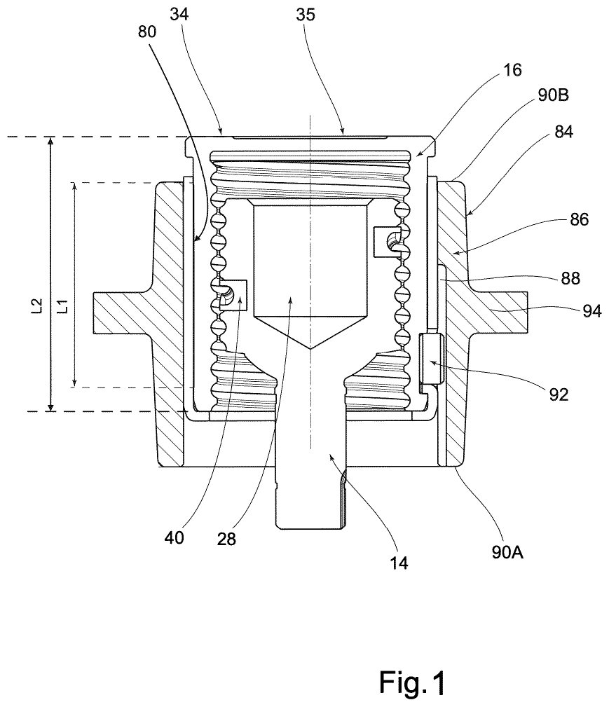

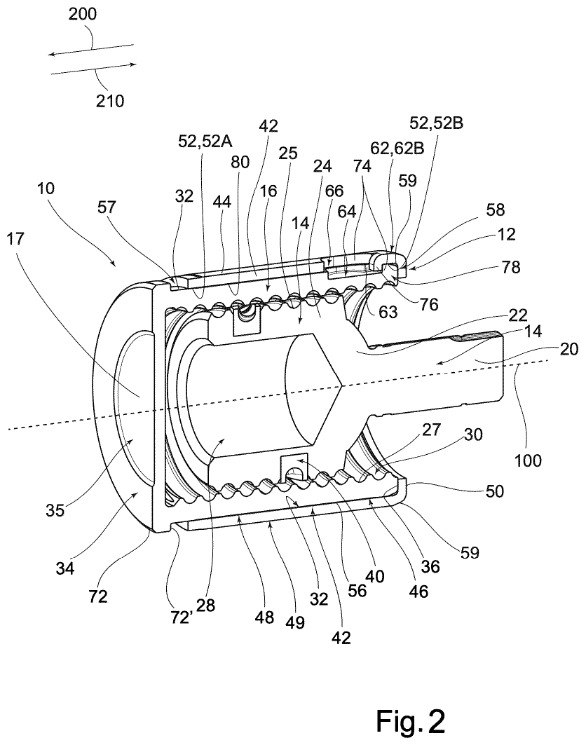

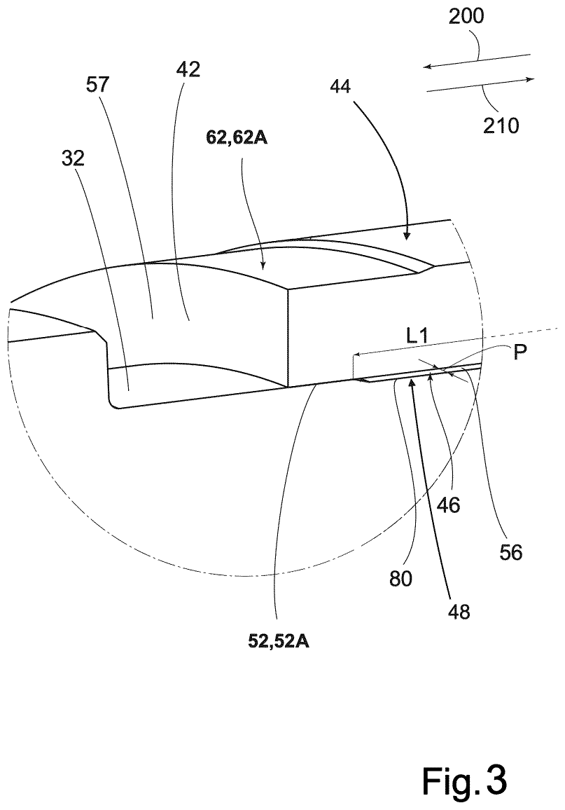

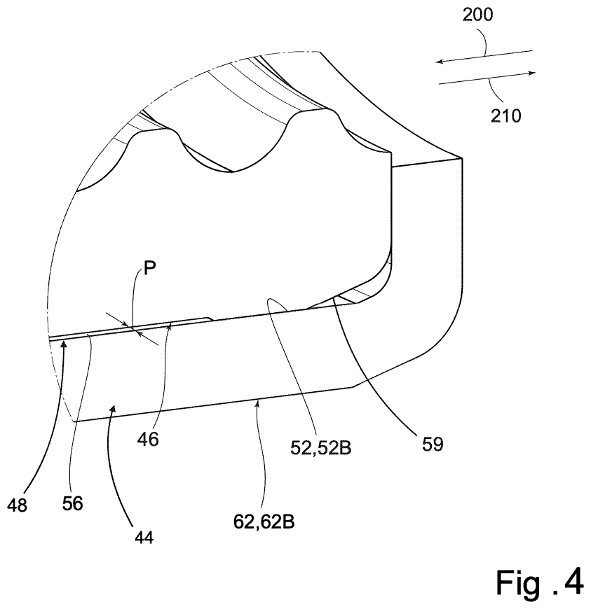

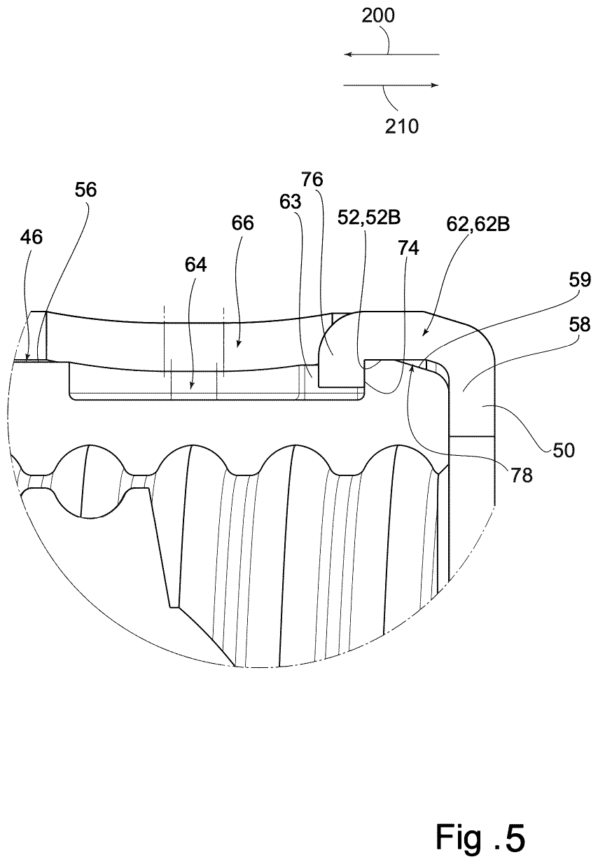

FIGS. 1 to 5 show a first embodiment of a brake actuator mechanism 10 comprising a fixed guide cylinder 84 and a piston 12 sliding in translation within the guide cylinder 84 along a reference axis 100, which is also a reference axis of the piston, to bear directly or indirectly against a brake pad (not shown). The piston 12 comprises a bushing 42 and a nut 16, the nut 16 being part of a ball screw mechanism comprising two threaded components, namely a screw 14 and the nut 16, and balls.

The guide cylinder 84 is made of a metal base, for example steel, and comprises a cylindrical guide body 86, preferably with a circular base, centered on the reference axis 100. The guide body 86 comprises a longitudinal locking groove 88, extending from a first open annular end 90A to a second open annular end 90B, over a predetermined distance. The locking groove 88 is configured to receive a slipper 92 in sliding contact, in order to lock the piston 12 in rotation with respect to the guide cylinder 84, while allowing it translational movement in the guide cylinder 84. In addition, the guide body 86 may comprise a positioning flange 94.

The screw 14 is preferably metallic, for example steel such as 20MnCr5, 23MnB4, Scr420, 16MnCr5 or their equivalents according to other international or national standards, or high-carbon steel such as 100Cr6, C50 or C56 or their equivalents, and may comprise a screw head 20 and a screw body 22, potentially linked by a connecting portion 22. The screw body 24 may have a larger diameter than the screw head 20. The screw head 20 is designed to be rotationally attached to the output shaft of an electric motor or gearmotor, and may have a non-circular interface, for example with four, six or eight hexagons.

The screw body 24 has a screw thread 25 which forms an inner helical raceway about the reference axis 100 of the ball screw mechanism, the inner helical raceway facing radially away from the reference axis 100. In addition, the screw 14 has an open central cavity 28 to lighten the overall weight of the brake actuator mechanism 10.

The nut 16 is made of steel, for example 20MnCr5, 23MnB4, Scr420, 16MnCr5 or their equivalents according to other international or national standards, or high-carbon steel such as 100Cr6, C50 or C56 or their equivalents. The nut 16 is cylindrical overall, with the reference axis 100 as its central axis. The nut 16 has a nut thread 27 which forms an outer helical raceway 30 about the reference axis 100 and facing radially toward the reference axis 100.

The nut 16 is of the closed type in the sense that it has a nut base 17, produced by an outer closure face 34, and forming a piston crown. The nut 16 has a generally cylindrical outer peripheral face 32 extending from the outer closure face 34 to an annular end face 36, over a length L2. The outer peripheral face 32 has a crimping mortise 63, a locking mortise 64 and a covered portion 80. The crimping mortise 63 has a crimping shoulder 74, rotated in an axial assembly direction 210. The covered portion 80 has a radially inward annular recess 46. The crimping mortise 63 and locking mortise 64 may be one and the same. The annular recess 46 extends over a length L1 parallel to the reference axis 100 and has a depth P measured radially between a bottom of the annular recess 46 and a cylindrical inner face 48 at the level of a guide zone 44 of the bushing 42 described below. The length L1 is greater than the depth P such that L1>20P, and L2 is greater than L1 such that

$$\frac{L 2}{2} < L 1 < L 2 .$$

The annular recess 46 can be obtained by molding the nut 16 or by machining, for example.

In addition, the outer peripheral face 32 of the nut 16 comprises two separate annular shrink-fit bearing surfaces 52, arranged on either side of the annular recess 46. The two annular shrink-fit bearing surfaces 52 open axially into the annular recess 46. Of the two annular shrink-fit bearing surfaces 52, a first annular shrink-fit bearing surface 52A is located in the vicinity of the outer closure face 34, while a second annular shrink-fit bearing surface 52B is located in the vicinity of the annular end face 36. The second annular shrink-fit bearing surface 52B is connected to the annular end face 36 via a chamfer 59. The two annular shrink-fit bearing surfaces 52 are configured to receive the bushing 42 in tight contact.

In addition, the outer closure face 34 may have a recess 35, the bottom of nut 16 being configured to come into direct or indirect contact with the brake pad (not shown in the figures). The outer closure face 34 further has a flange 72, projecting radially from the outer peripheral wall 32, which forms a flange shoulder 72′. The flange 72 further limits any deformation of the outer closure face 34 under mechanical stress when the brake actuator mechanism 10 is activated, for example.

One of the two threaded components, that is, the screw 14 or nut 16, may further be equipped with means 40 for recirculating the balls, which may comprise one or more recirculators each passing through one or more threads of the threaded component, as shown in FIG. 1, or pairs of recirculators arranged at the ends of a recirculation channel that spans one or more turns of the raceways of the screw 14 and nut 16. In this embodiment, ball recirculation is internal, that is, comprising at least one recirculator each passing through a thread on screw 14.

The balls can be made of steel or ceramic, for example, and are sized and positioned to circulate in a closed circuit between the outer helical raceway 30 of the nut 16 and the inner helical raceway 25 of the screw 14, as well as, if need be, by the recirculation means 40, preferably without separators between the balls.

The bushing 42 is metallic, for example made of steel, for example 20MnCr5, 23MnB4, Scr420, 16MnCr5 or their equivalents according to other international or national standards, or high-carbon steel such as 100Cr6, C50 or C56 or their equivalents. The bushing 42 has a cylindrical inner face 48 and a cylindrical outer face 49 which are radially opposed and extend from a first end 57 of the bushing 42 to a second end 58 of the bushing 42. The bushing 42 has a locking slot 66, such as a generally rectangular or oblong through-hole, located close to the annular end face 36 of the nut 16. The locking slot 66 gives access to the locking mortise 64 of the nut 16.

The bushing 42 has an inward flap of crimping material 76, designed to be supported on the crimping mortise 63, at the crimping shoulder 74 of the crimping mortise 63. In addition, the bushing 42 may optionally feature a bushing 42 shoulder 50 located at the second end 58 of the bushing 42, facing in an axial assembly direction 210. The bushing 42 shoulder 50 rests axially on the annular end face 36 of the nut 16, opposite the base 17 of the nut 16. The flap of crimping material 76 and the bushing 42 shoulder 50 have generally parallel bearing faces and, joined by the cylindrical inner face 48 of the bushing 42, form a crimping groove 78. The crimping groove 78 is configured to receive at least part of the nut 16 in tight contact.

In addition, the bushing 42 has a guide zone 44 and two shrink-fit zones 62, namely a first shrink-fit zone 62A located near the first end 57 of the bushing 42 and a second shrink-fit zone 62B located near the second end 58 of the bushing 42. The guide zone 44 is intended, via the cylindrical outer face 49, to come into close sliding contact with the inner guide wall of the guide cylinder 84. The guide zone 44 is intended, via the cylindrical inner face 48, to cover the covered portion 80 of the nut 16 without shrink-fitting, and preferably without contact. Each shrink-fit zone 62 is intended to come into tight contact with the outer peripheral face 32 of the nut 16 at the two annular shrink-fit bearing surfaces 52. The guide zone 44 and the two shrink-fit zones 62 may be joined by chamfers to facilitate insertion of the piston 12 into the guide cylinder 84.

More specifically, the first shrink-fit zone 62A is designed to come into tight contact with the first annular shrink-fit bearing surface 52A, while the second shrink-fit zone 62B is designed to come into tight contact with the second annular shrink-fit bearing surface 52B. The guide zone 44 has an outer diameter greater than the outer diameter of the first shrink-fit zone 62A, in order to limit any deformation caused by the methods for assembling the bushing 42 on the nut 16 to a diameter less than or equal to the diameter of the guide zone 44. The guide zone 44 has an outer diameter greater than or equal to the outer diameter of the second shrink-fit zone 62B, since the second shrink-fit zone 62B is located in the vicinity of the second end 58 of the bushing 42, comprising the bushing shoulder 50, the curvature of which stiffens the bushing 42 in this region of the bushing 42.

The brake actuator mechanism 10 also comprises a slipper 92, shrink-fitted into the locking mortise 64, projecting radially toward the guide cylinder 84 through the locking slot 66, relative to the outer face of the bushing 42.

When the piston 12 of the brake actuator mechanism 10 is assembled, the nut 16 is force-fitted into the bushing 42 without risk of snagging, owing to the various chamfers it incorporates. The insertion takes place in the axial direction of assembly 210, until the annular end face 36 of the nut 16 abuts against the bushing shoulder 50. The bushing 42 is shrink-fitted onto the nut 16 via the two shrink-fit zones 62, at the two annular shrink-fit bearing surfaces 52, thus forming a one-piece unit consisting of the nut 16 and the bushing 42, that is, the piston 12. The first shrink-fit zone 62A is shrink-fitted onto the first annular shrink-fit bearing surface 52A, the second shrink-fit zone 62B is shrink-fitted onto the second annular shrink-fit bearing surface 52B, and the guide zone 44 faces the outer peripheral wall 32 of the nut 16 without contact due to the annular recess 46. The outer peripheral wall 32 of the nut 16 and the cylindrical inner face 48, due to the annular recess 46, are then spaced apart by an intermediate annular space 56.

The intermediate annular space 56 has the same dimensions as the annular recess 46, such as length or depth. The intermediate annular space 56 compensates for deformations of the bushing 42 when it is shrink-fitted onto the nut, and/or of the nut 16 when the volume of the nut 16 increases as a result of temperature variations when the piston 12 is operating in its operating environment. In this way, the diameter of the bushing 42, and more specifically the outside diameter of the guide zone 44, that is, the outer face of the bushing 49, is maintained at a relatively constant value, so as to preserve the desired properties during production of brake actuator mechanism 10.

The assembly is carried out with angular indexing so that:
the locking mortise 64 of the nut 16 and the locking slot 66 of the bushing 42 are located opposite one another, and the locking slot 66 allows access to the locking mortise 64; and
the crimping mortise 63 of the nut 16 and the flap of crimping material 76 of the bushing 42 are made opposite each other.

The flap of crimping material 76, initially oriented parallel to the reference axis 100, is then folded radially inwards into the crimping mortise 63 to secure the bushing 42 and nut 16 together. The slipper 92 is then inserted into the locking mortise 64 of the nut 16 through the locking slot 66. When the crimping mortise 63 merges with the locking mortise 64, the slipper 92 can come into contact with the flap of crimping material 76, providing additional securing between the bushing 42 and the nut 16.

The screw 14 is then inserted into the nut 16 of the piston 12, using a progressive helical movement.

The sub-assembly consisting of the screw 14 and piston 12 fitted with the slipper 92 is then inserted into the guide cylinder 84 in the axial assembly direction 210. To do this, the locking slot 66 of the bushing 42 and the locking mortise 64 of the nut 16 must be inserted into the locking groove 88 of the guide body 86 of the guide cylinder 84, while the slipper 92 enters the locking groove 88. The guide zone 44 of the outer face of the bushing 42 then comes into rotation-free translational sliding contact with the inner guide wall of the guide body 86.

The slipper 92 inserted in the locking groove 88 has only one degree of freedom, within the functional clearances, in translation parallel to the reference axis 100 in the locking groove 88. The slipper 92 then locks the piston 12 in rotation about the reference axis 100, while allowing it a degree of translational freedom parallel to the reference axis 100.

In operation, a rotational movement of the screw 14 about the reference axis 100, driven in rotation at the screw head 20 by a motor, generates a translational movement of the piston 12 in a direction which is based on the direction of rotation of the screw 14.

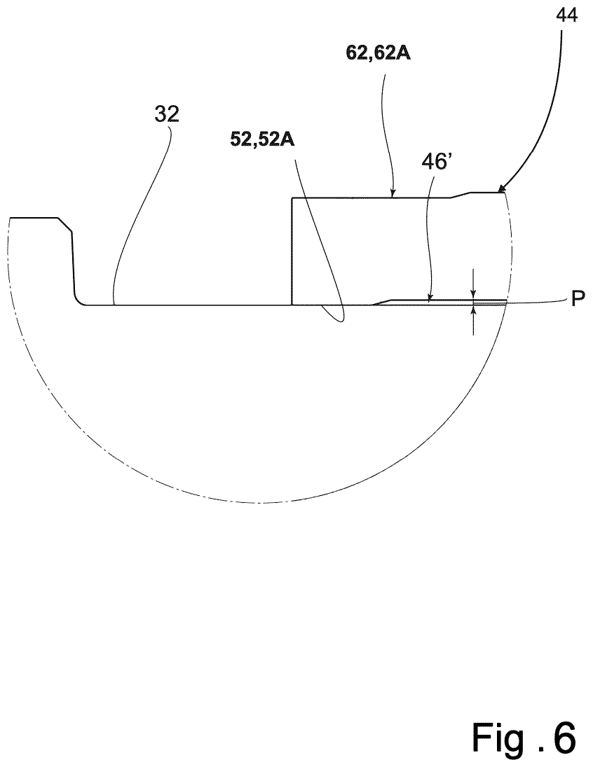

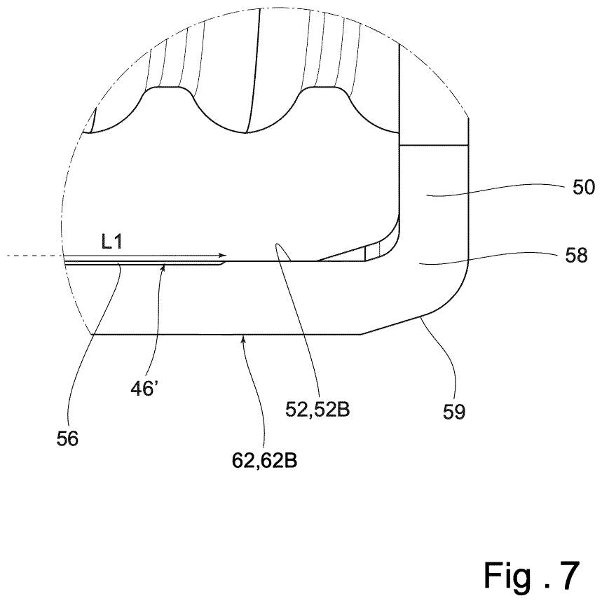

According to a second embodiment, shown in FIGS. 6 and 7, the brake actuator mechanism 10 differs from that described in the first embodiment in that the brake actuator mechanism 10 has no annular recess 46 of the nut 16. In addition, the bushing has a secondary, radially outward annular recess 46′, at the cylindrical inner face 48. The intermediate annular space 56 is then generated by the secondary annular recess 46′, having the same advantageous characteristics as when it is generated by the annular recess 46 of the nut 16.

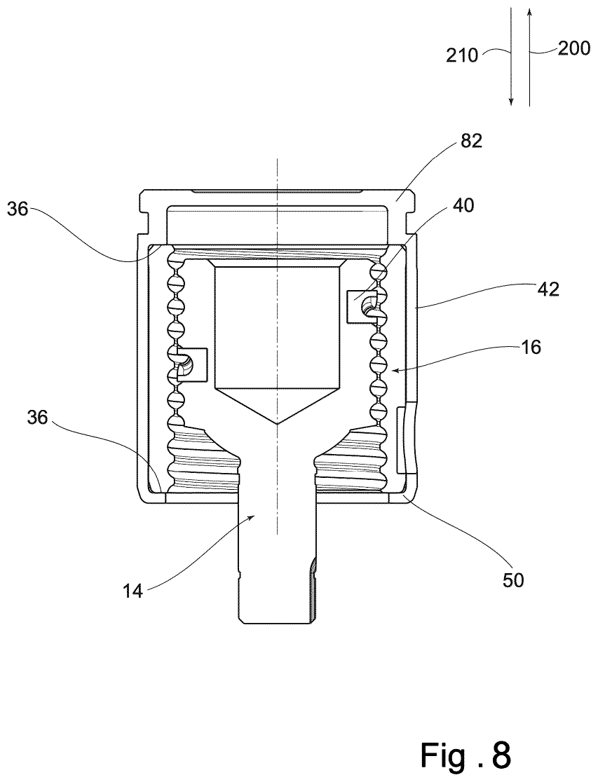

According to a third embodiment shown in FIG. 8, the brake actuator mechanism 10 differs from that described in the first two embodiments in that the nut 16 does not comprise a nut base 17. The nut 16 then comprises two annular end faces 36 of the nut 16. The piston then comprises a piston crown formed by the bushing 42, and more particularly by a bushing crown 82. The nut is then inserted into the bushing 42 in a second axial assembly direction 200, opposite to the axial assembly direction 210 but along the same axis. The shoulder 50 of the bushing 42, projecting axially from the annular end face 36 of the nut 16 opposite the bushing crown 82, if present, is then produced by folding back the material after assembling the bushing 42 onto the nut 16. However, this shoulder 50 is optional.

In all the embodiments described above, the bushing 42 may undergo thermochemical treatment to resist abrasion and corrosion at a temperature Ts until a nitrogen-rich abrasion- and corrosion-resistant surface layer is obtained, prior to assembly on the nut 16. The treatment to obtain such a layer includes nitriding or nitrocarburizing, with the temperature Ts ranging from 300° C. to 580° C. Nitriding and/or nitrocarburizing enable nitride to form on the surface when a part is placed in a very nitrogen-rich treatment atmosphere at temperature Ts, allowing a different material to form on the surface. Owing to this treatment, the outer face 49 of the bushing 42 of the piston 12 is resistant to abrasion and corrosion that could occur under operating conditions, when the piston 12 slides in translation in the guide cylinder 84. Since nitrocarburizing does not alter the flatness of a surface, it is possible to grind the outer face 49 of the bushing 42 before applying the thermochemical treatment.

Similarly, the nut 16 may be subjected to a thermochemical hardening treatment including heating to a temperature Tc at least 200° C. higher than Ts, preferably at least 900° C. higher. The thermochemical hardening treatment, for example of the surface or core carburizing type, then includes quenching and tempering at a temperature Tr at least 100° C. below Ts, preferably below 200° C. This treatment produces a hardened, carbon-rich surface layer at least locally on the nut thread 27 of the inner surface of the nut 16. Owing to this treatment, the nut thread 27 has increased surface and depth hardness, making it more durable by resisting chipping, for example. However, carburizing modifies the flatness of a workpiece surface, so it is necessary to carry out a grinding, hard turning or hard milling step on the inner surface of the nut 16 after the thermochemical treatment has been applied.

In addition, the part in contact with the brake pad, that is, the piston base, formed by the outer closure face 34 or the bushing crown 82, can be given an additional surface coating. This additional treatment is, for example, an application of zinc flake on the surface or another surface treatment method. This additional treatment makes the outer closure face 34 or the bushing crown 82 more resistant to corrosion when the brake actuator mechanism 10 is actuated. Alternatively, in the embodiment shown in FIGS. 1 to 4, the carburizing of the nut may impart sufficient corrosion resistance to the outer closure face 34.

Naturally, the examples shown in the figures and discussed above are provided for illustrative and non-limiting purposes only. It is explicitly provided that it is possible to combine the various illustrated embodiments in order to provide others.

In another variant, not shown, the recirculation means 40 are formed at the nut 16, which has an external recirculation channel and recirculators, enabling external recirculation of the balls, that is, within the thickness of the nut 16. Here, the recirculation channel may be open and closed again when the brake actuator mechanism 10 is assembled by the cylindrical inner face 48 of the bushing 42.

In a further variant not shown, the brake actuator mechanism 10 may have an annular bellows, comprising an annular base configured to fit into an annular recess of the guide cylinder 84, and a bellows head configured to be clamped between the flange shoulder 72′ of the flange 72, and the bushing 42, radially abutting the outer peripheral wall 32 or in an annular groove made in the solid-crown bushing of the embodiment shown in FIG. 8. This annular bellows prevents the ingress of contaminants into the guide cylinder 84 by providing a primary seal.

In another variant, not shown, the nut 16 has a single annular seat 52 and the bushing 42 has a single shrink-fit zone 62.

In another variant, not shown, the brake actuator mechanism 10 has the annular recess 46 of the nut 16 and the secondary annular recess 46′ of the bushing 42. The intermediate annular space 56 is then generated by the annular recess 46 and the secondary annular recess 46′.

1. A piston of an actuator mechanism, the piston comprising:
a nut of a worm gear mechanism, defining a reference axis, an outer peripheral wall and a nut thread intended to cooperate, directly or via balls, with a screw of the worm gear mechanism;
a bushing secured to the nut and at least partially covering the outer peripheral wall of the nut, the bushing comprising a cylindrical guide zone intended to come into close sliding contact with an inner guide wall of a guide cylinder of the actuator mechanism;
wherein the nut comprises at least one annular shrink-fit bearing surface, the bushing comprises at least one shrink-fit zone shrink-fitted onto the at least one annular shrink-fit bearing surface, the cylindrical guide zone having an outer diameter greater than that of the at least one shrink-fit zone and overlapping, without contact or shrink-fitting, a covered portion of the outer peripheral wall of the nut.

2. The piston of claim 1, wherein the cylindrical guide zone and the covered portion of the outer peripheral wall of the nut are separated by an intermediate annular space generated by:
an annular recess in the covered portion of the outer peripheral wall of the nut relative to the at least one annular shrink-fit bearing surface; and/or
an inner diameter of the cylindrical guide zone greater than an inner diameter of the at least one shrink-fit zone.

3. The piston of claim 2, wherein the intermediate annular space has a length L1 measured parallel to the reference axis, and a depth P, measured radially between the outer peripheral wall of the nut and a cylindrical inner face of the bushing cylindrical guide zone of the bushing, and the nut has a nut length L2 measured along an axis parallel to the reference axis between two ends of the nut, such that
$$L 1 > 20 P ; and / or$$
$$\frac{L 2}{2} < L 1 < L 2 .$$

4. The piston of any of claim 1, wherein the nut comprises a second annular shrink-fit bearing surface, and the bushing comprises a second shrink-fit zone in contact with the second annular shrink-fit bearing surface of the nut.

5. The piston of claim 4, wherein the at least one shrink-fit zone and the second shrink-fit zone are located at two opposite axial ends of the cylindrical guide zone.

6. The piston of claim 1, wherein the bushing has a shrink-fit end-of-stroke shoulder turned in an axial assembly direction, bearing against an annular end face of the nut.

7. The piston of claim 1, wherein the nut comprises a crimping mortise and the bushing has a flap of crimping material penetrating the crimping mortise and bearing against a crimping shoulder of the crimping mortise.

8. The piston of claim 1, wherein the nut comprises a locking mortise and the bushing has a locking slot open onto the locking mortise, the piston further comprising a slipper inserted into the locking mortise and projecting radially with respect to the cylindrical guide zone.

9. The piston of claim 1, wherein the bushing comprises a nitrogen-rich abrasion- and corrosion-resistant surface layer, and the nut comprises a carbon-rich hardened surface zone at least locally at the nut thread.

10. The piston of claim 1, wherein the piston has a piston crown.

11. A brake actuator mechanism, comprising:
a guide cylinder;
a ball screw mechanism, comprising a screw and a nut defining a reference axis of the brake actuator mechanism, coaxial with the guide cylinder, and balls, the screw having at least one screw thread forming a raceway for the balls, the nut having a nut thread forming an outer helical raceway for the balls and an outer peripheral wall; and
a bushing secured to the nut and at least partially covering the outer peripheral wall of the nut, the bushing coming into close sliding contact with an inner guide wall of the guide cylinder;
wherein the nut comprises at least one annular shrink-fit bearing surface, the bushing comprises at least one shrink-fit zone shrink-fitted onto the annular shrink-fit bearing surface, the cylindrical guide zone having an outer diameter greater than that of the shrink-fit zone and overlapping, without contact or shrink-fitting, a covered portion of the outer peripheral wall of the nut.

12. The piston of claim 11, wherein the cylindrical guide zone and the covered portion of the outer peripheral wall of the nut are separated by an intermediate annular space generated by:
an annular recess in the covered portion of the outer peripheral wall of the nut relative to the annular shrink-fit bearing surface; and/or
an inner diameter of the cylindrical guide zone greater than an inner diameter of the shrink-fit zone.

13. The piston of claim 12, wherein the intermediate annular space has a length L1 measured parallel to the reference axis, and a depth P, measured radially between the outer peripheral wall of the nut and a cylindrical inner face of the bushing cylindrical guide zone of the bushing, and the nut has a nut length L2 measured along an axis parallel to the reference axis between two ends of the nut, such that
$$L 1 > 20 P ; and / or$$
$$\frac{L 2}{2} < L 1 < L 2 .$$

14. The piston of any of claim 11, wherein the nut comprises a second annular shrink-fit bearing surface, and the bushing comprises a second shrink-fit zone in contact with the second annular shrink-fit bearing surface of the nut.

15. The piston of claim 14, wherein the at least one shrink-fit zone and the second shrink-fit zone are located at two opposite axial ends of the cylindrical guide zone.

16. The piston of claim 15, wherein the bushing has a shrink-fit end-of-stroke shoulder turned in an axial assembly direction, bearing against an annular end face of the nut.

17. The piston of claim 11, wherein the nut comprises a crimping mortise and the bushing has a flap of crimping material penetrating the crimping mortise and bearing against a crimping shoulder of the crimping mortise.

18. The piston of claim 11, wherein the nut comprises a locking mortise and the bushing has a locking slot open onto the locking mortise, the piston further comprising a slipper inserted into the locking mortise and projecting radially with respect to the cylindrical guide zone.

19. The piston of claim 11, wherein the bushing comprises a nitrogen-rich abrasion- and corrosion-resistant surface layer, and the nut comprises a carbon-rich hardened surface zone at least locally at the nut thread.

20. The piston of claim 11, wherein the piston has a piston crown.
